(19) United States
(12) Patent Application Publication
(10) Pub. No.: US 2006/0193941 A1
(43) Pub. Date: Aug. 31, 2006

(54) MOLD CORE AND RELATED MOLD FOR INJECTION MOLDING

(76) Inventor: Ga-Lane Chen, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/164,705

(22) Filed: Dec. 2, 2005

(30) Foreign Application Priority Data
Dec. 3, 2004 (TW) 093137381

(51) Int. Cl. B29C 45/20

(52) U.S. Cl. 425/556; 425/577

(57) ABSTRACT

This invention relates to a mold core and a mold for injection molding of an article, for example, a light guide plate. The mold core comprises a male mold portion (20) and a female mold portion (30). The male mold portion includes a plurality of detachable parts (21,22,23) that can be combined or separated easily. The detachable parts include a bottom plate having a raised platform and two pairs of side plates configured to surround the raised platform. The mold comprises a male mold plate (60), a female mold plate (70), a pushing rod (40) and an above-described mold core.

### FIELD OF THE INVENTION

The invention relates generally to mold cores and related molds for injection molding and, more particularly, to a mold core and a related mold for injection molding of an article, for example, a light guide plate.

### DESCRIPTION OF RELATED ART

Liquid crystal display devices have been widely used in notebook computers or portable TVs. A typical liquid crystal display device generally comprises a liquid crystal panel and a backlight system. The backlight system is for providing uniform collimated light to the liquid crystal panel. The backlight system mainly comprises a light source and a light guide plate. The light guide plate, which is made of a transparent acrylic resin, is used for guiding the light emitted from the light source to uniformly illuminate the liquid crystal panel.

The most popular method of manufacturing the light guide plate is an injection molding method. In the case of the injection molding method, a resin material is injected into a mold to form a light guide plate. The light guide plate is then removed from the mold. Referring to FIG. 5, a conventional mold core includes a male mold portion 10, a female mold portion 11. The male mold portion 10 and the female mold portion 11 cooperatively form a mold cavity (not shown) therebetween. The female mold portion 11 has a sprue 13 for injecting molding materials into the mold cavity. After a light guide plate (not shown) is formed, a pushing rod 14 is utilized to push the light guide plate out of the mold core.

However, abrasion/scratch may usually occur between an inner surface of the mold cavity and the light guide plate during removing the light guide plate from the mold core by the pushing rod 14. This may scratch or even damage the outer surface of the light guide plate.

What is needed, therefore, is a mold which can separate a light guide plate from the mold frictionless, so that minimize or even eliminate potential risks of damage of the light guide plate during a mold release process.

### SUMMARY OF INVENTION

In one embodiment, a mold core for use in injection molding of an article, such as a light guide plate, comprises a male mold portion and a female mold portion. The male mold portion includes a plurality of detachable parts. The detachable parts of the male mold include a bottom plate having a raised platform and two pairs of side plates configured to surround the raised platform. The female mold portion is configured to mating with the male mold portion. The plurality of detachable parts and the female mold portion are capable of cooperatively forming a mold cavity there among.

In another embodiment, a mold for injection molding of an article comprises a male mold plate, a female mold plate, a pushing rod and a above-described mold core. The male mold plate is concave and has a punch hole, and a female mold plate is also concave and is matched to the male mold plate. The male mold portion of the above-described mold core is placed in the male mold plate. Similarly, the female mold portion of the above-described mold core is placed in the female mold plate. The pushing rod is placed in the punch hole of the male mold plate and touches with the male mold portion for pushing the male mold portion out of the male mold plate.

Compared with a conventional mold for injection molding of a light guide plate, because a male mold portion of the present invention is assembled by a plurality of detachable parts, so that the male mold portion is easy to combine together for injection molding and is also easy to divide for separating a light guide plate from the mold. Because the separation process is frictionless, the present invention can reduce the damage of the light guide plate.

Other advantages and novel features of the present invention will become more apparent from the following detailed description of preferred embodiments when taken in conjunction with the accompanying drawings.

### BRIEF DESCRIPTION OF DRAWINGS

Many aspects of the present mold core and related mold can be better understood with reference to the following drawings. The components in the drawings are not necessarily to scale, the emphasis instead being placed upon clearly illustrating the principles of the present mold core and related mold.

FIG. 1 is a schematic, cross-sectional view of a mold core for injection molding of an article in accordance with a preferred embodiment;

FIG. 2 is a schematic, isometric view of a male core portion of the mold core of FIG. 1;

FIG. 3 is a schematic, exploded view of the male core portion of FIG. 2;

FIG. 4 is a schematic, cross-sectional view of a mold in accordance with another preferred embodiment, showing a male mold portion and a male mold portion; and

FIG. 5 is a schematic, cross-sectional view of a conventional mold for injection molding.

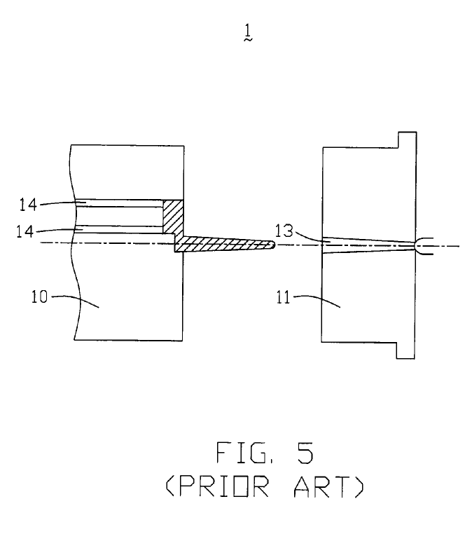

Corresponding reference characters indicate corresponding parts throughout the several views. The exemplifications set out herein illustrate at least one preferred embodiment of the present invention, in one form, and such exemplifications are not to be construed as limiting the scope of the invention in any manner.

### DETAILED DESCRIPTION

Reference will now be made to the drawings to describe embodiments of the present invention, in detail.

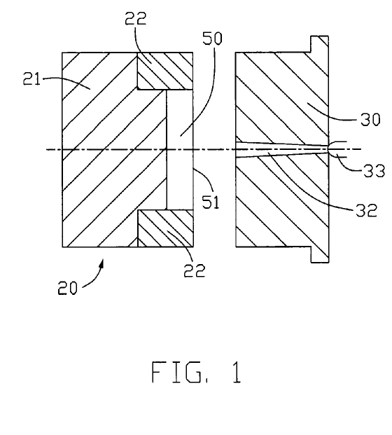

Referring to FIG. 1, a mold core of a mold for injection molding of a light guide plate according to an exemplary embodiment is shown. The mold core essentially includes a male mold portion 20 (also referred to as a core portion) and a female mold portion 30 (also referred to as a cavity portion). The male mold portion 20 and the female mold portion 30 cooperatively form a mold cavity 50 therebetween. The mold cavity 50 has a top opening and an inner space 52. The inner space 52 is defined in the male mold portion 20. The top opening 51 corresponds to and is covered/bounded by a molding surface 51 of the cavity portion 30 that faces the inner space 52.

The female mold core 30 has a sprue 32 and a gate 33. The sprue 32 and the gate 33 are in communication with the mold cavity 50. For forming micro optical patterns on a surface of the light guide plate, various patterns such as concave, convex, saw-shaped, V-shaped or U-shaped protrusions/grooves may be formed on the molding surface 51 of the female mold portion 30.

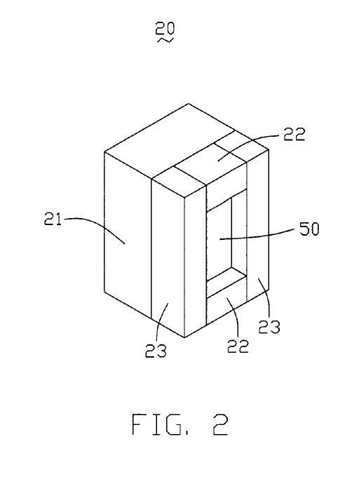

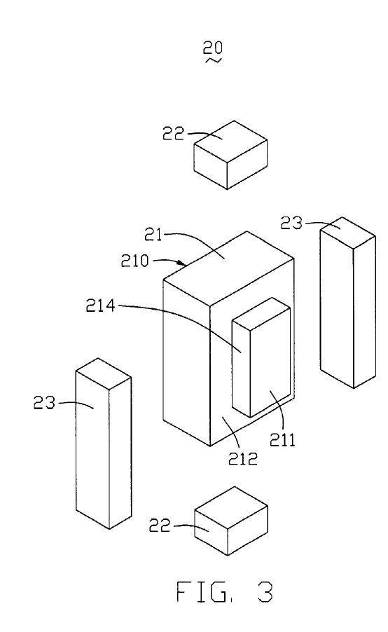

FIG. 2 shows an isometric view of the male mold portion 20. FIG. 3 shows an exploded, schematic view of the male mold portion 20. Referring to FIG. 2 and FIG. 3, the male mold portion 20 includes a bottom plate 21 and two pairs of detachable side plates 22,23. The bottom plate 21 has a bottom surface 210, a first surface 211 and a second surface 212. The bottom surface 210 is flat. The first surface 211 is a top surface of a raised platform 214 of the bottom plate 21. In assembly, the two pairs of side plates 22,23 are disposed on the second surface 212 and abut against side surfaces of the raised platform 214. The male mold portion 20 is essentially a cubic body with the mold cavity 50 being bounded by the raised platform 24 and the side plates 22,23.

The light guide plate is generally a flat sheet having a uniform thickness or wedge-shaped block. Accordingly, the first surface 211 may be configured to be parallel to the bottom surface 210 corresponding to the flat light guide plate. Alternatively, the first surface 211 could be configured to be inclined relative to the bottom surface 210 at an angle, corresponding to the wedge-shaped light guide plate. If the first surface 211 is parallel to the bottom surface 210, the resultant light guide plate is flat. If the first surface 211 is inclined relative to the bottom surface 210, the resultant light guide plate is wedge-shape.

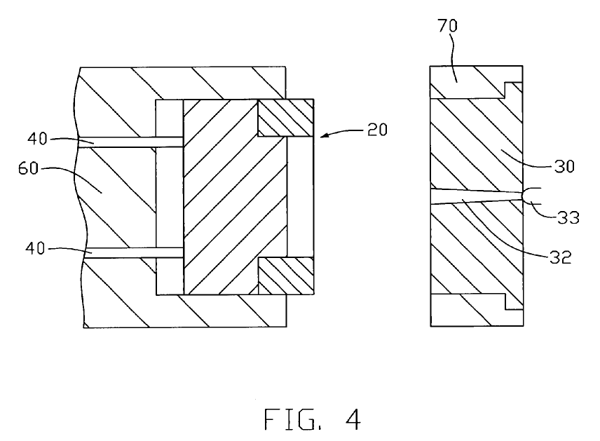

FIG. 4 shows an exemplary mold for injection molding of for example a light guide plate. Referring to FIGS. 3 and 4, the mold includes a male mold plate 60, a female mold plate 70, two ejection rods 40 and the mold core 20. The male mold plate 60 and the female mold plate 70 can be assembled to each other, thereby the mold 20 is held therebetween. The mold may further include a cooling device and cooling channels (not shown) for cooling the mold during the injection molding process. The male mold plate 60 is used to secure of the separate parts 21,22,23 to form the mold cavity 50. The ejection rods 40 are arranged in the male mold plate 60 and abut against the bottom surface 210 of the male mold portion. During the molding process, the pushing rod 40 is forced so as to exert a pressure upon the bottom plate 21. The light guide plate and the male mold portion 20 are then push out using the ejection rod 40. The male mold portion 20 is then s manually or automatically disassembled into separate parts, thereby the light guide plate is readily removed from the male mold portion 20.

Compared with a conventional mold for injection molding of a light guide plate, the present male mold portion 20 is essentially an assembly of a number of separate element. The male mold portion 20 is readily to be combined together for injection molding. The male mold portion 20 is also readily to be disassembled for facilitating the removing of the resultant light guide plate therefrom. This configuration of the male mold portion 20 can effectively minimize or even eliminate the potential risks of scratch or even damage of the light guide plate during a mold release process.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A mold core for use in a mold for injection molding of an article, the mold comprising:
a male mold portion comprising a plurality of detachable parts; and
a female mold portion configured to mating with the male mold portion;
wherein the plurality of detachable parts and the female mold portion are capable of cooperatively forming a mold cavity thereamong.

2. The mold core as claimed in claim 1, wherein the detachable parts of the male mold include a bottom plate having a raised platform and two pairs of side plates configured to surround the raised platform.

3. The mold core as claimed in claim 2, wherein the bottom plate and two pairs of side plates cooperatively form the mold cavity.

4. The mold core as claimed in claim 2, wherein the raised platform of the bottom plate is flat.

5. The mold core as claimed in claim 2, wherein the raised platform of the bottom plate is wedge-shaped.

6. The mold core as claimed in claim 2, wherein the bottom plate has a flat bottom surface.

7. The mold core as claimed in claim 1, wherein the female mold portion has a sprue in communication with the mold cavity.

8. The mold core as claimed in claim 1, wherein the female mold portion has a molding surface facing to the mold cavity, the molding surface having a predetermined pattern thereon.

9. The mold core as claimed in claim 8, wherein the pattern is selected from the group of saw-shaped, V-shaped and U-shaped patterns.

10. A mold for injection molding of an article, the mold comprising:
a male mold holder;
a female mold holder mating with the male mold;
an ejection bar arranged in the male mold holder; and
an mold core comprising a male mold portion and a female mold portion, the male mold portion comprising a plurality of detachable parts, the plurality of detachable parts and the female mold portion cooperatively forming a mold cavity thereamong;
wherein the male mold portion is disposed in the male mold holder, the female mold portion is disposed in the female mold holder, and the ejection bar abuts against the male mold portion.

11. The mold as claimed in claim 10, wherein the detachable parts of the male mold portion include a bottom plate having a raised platform and two pairs of side plates configured to surround the raised platform.

12. The mold as claimed in claim 11, wherein the bottom plate and two pairs of side plates cooperatively form the mold cavity.

13. The mold as claimed in claim 11, wherein the raised platform of the bottom plate is flat.

14. The mold as claimed in claim 11, wherein the raised platform of the bottom plate is wedge-shaped.

15. The mold as claimed in claim 11, wherein the bottom plate has a flat bottom surface.

16. The mold as claimed in claim 15, wherein the ejection bar abuts against the flat bottom surface of the bottom plate for pushing the male mold portion out of the male mold holder.

17. The mold as claimed in claim 10, wherein the female mold portion has a sprue in communication with the mold cavity.

18. The mold as claimed in claim 10, wherein the female mold portion has a molding surface facing the mold cavity, the molding surface having a predetermined pattern thereon.

19. The mold as claimed in claim 10, wherein the pattern is selected from the group of saw-shaped, V-shaped and U-shaped one of protrusions and grooves.
